(19) United States
(12) Patent Application Publication
(10) Pub. No.: US 2007/0130289 A1
(43) Pub. Date: Jun. 7, 2007

(54) Remote access

(76) Inventors: Christopher Defazio, Omaha, NE (US); Thomas L. Hester, La Vista, NE (US)

Correspondence Address: FISH & RICHARDSON P.C., P.O. BOX 1022, MINNEAPOLIS, MN, 55440-1022, US

(21) Appl. No.: 11/295,503

(22) Filed: Dec. 7, 2005

(51) Int. Cl. G06F 15/16

(52) U.S. Cl. 709/218

(57) ABSTRACT

A computer system is able to remotely access applications and data through a proprietary user computer system. Once the computer system seeking access has been authenticated, the remote proprietary user computing system is powered on. A conduit computing system is used to channel user input signals received over a general communications network from the accessing computer system to the remote proprietary user computing system. The channeled user input signals serve as inputs used in the execution of an application residing on the powered-on remote proprietary user computing system. The conduit computing system also channels screen images, captured at the remote proprietary user computing system, to the accessing computer system over the general communications network.

### TECHNICAL FIELD

This description relates to remote access of a software application running on a user computer that is accessible through a network.

### BACKGROUND

For many businesses, enabling an employee to securely access software applications installed on the employee's office computer system when the employee is outside of the office is an important issue. Providing such access may become quite complex when the accessed application uses proprietary data. In some cases, to provide remote access, proprietary data is copied to an accessing computer system, which exposes the proprietary data to potential compromise. Sometimes specialized communication software may be required to enable remote access to the employee's computer system, which may further complicate enabling remote access. A method of securely enabling remote access to software applications installed on a computer system without copying or otherwise transferring data being accessed to the accessing computer system would be beneficial.

### SUMMARY

In one general aspect, accessing a remote computing system includes receiving, at a conduit computing system, user-initiated messages from a first computing system connected to the conduit computing system by a first network. A user-initiated message includes information indicating authorization for access to a remote computing system connected to the conduit system by a second network. In response to receiving the user-initiated message, the conduit computing system sends a message instructing the remote computing system to power on. The message is sent from the conduit computing system, over the second network, to the remote computing system. The conduit computing system channels user input signals received over the first network. The user input signals are channeled from the first computing system to the remote computing system. The user input signals serve as inputs that are used in the execution of an application through the powered-on remote computer system. The conduit computing system also channels, in return, screen images captured at the remote computing system and received over the second network from the remote computing system. The screen images are channeled to the first computing system over the first network.

Implementations may include one or more of the following features. For example, the screen images may be interactive screen images that are able to receive user-inputs from a user operating the first computing system. A user-initiated message may include a request to access a specified remote computing system connected to the conduit system by a second network. A message may be sent to the remote computing system only after a determination is made that a user operating the authorized accessing computing system is permitted to access the specified remote computing system.

Information indicating authorization for the requested access may include user authentication information. A remote computing system may be assigned and to be made accessible to a user identified by the user authentication information.

A user may be permitted to access a remote computing system provided by, for example, an educational institution, a library or a research institution. The second network may include a network operated for the purpose of continuity of operations and made available to multiple organizational entities. The second network may be made concurrently available to multiple organizational entities.

The application may reside on the powered-on remote computer system. The first computing system may be a personal computer, a mobile computer, a personal digital assistant or a mobile telephone.

Information indicating authorization for access may include a combination of a user name and a password, a single-use password, or a cryptographic authentication credential. When the information indicating authorization for access to the remote computing system includes information indicating authorization for access to a specific remote computing system, a user-initiated message may be received, at the conduit computing system, from the first computing system and may include information indicating authorization for access to the second network. User input signals and the screen images may be channeled conditioned upon authorization for access to the second network and authorization for access to the specific remote computing system.

The second network may be a proprietary network operated by a business enterprise. The second network may be a home network, and the conduit computing system may be a router operating as a gateway to the home network. The first network may be a general communications network, and the second network may be a proprietary communications network.

A determination may be made as to whether the remote computing system is powered-on prior to sending the message over the second network to the remote computing system instructing the remote computing system to power on. The message instructing the remote computing system to power on may be sent only in response to a determination that the remote computing system is not powered on.

In another general aspect, a system for accessing computer applications on a remote user computer includes an authentication computer system, a waking computer system and a communication-conduit computer system. The authentication computer system is accessible over a first network and connected to a second network. The authentication computer system is configured to determine whether a user identity operating on a first computing system is permitted to access the second network. The waking computer system is connected to the second network and is configured to power-on a remote user computer conditioned upon a determination that the user identity is permitted to access the remote user computer. The communication-conduit computer system is connected to the second network and configured to channel user input signals received over the first network from the first computing system and to the remote computing system. The user input signals serve as inputs used in the execution of an application through the powered-on remote computer system. The communication-conduit computer system channels, in return, screen images captured at the remote computing system and received over the second network from the remote computing system to the first computing system over the first network.

Implementations may include one or more of the features noted above and one or more of the following features. For example, the waking computer system may be a different computer system than the communication-conduit computer system, or may be the same computer system as the communication-conduit computer system. Functions performed by the authentication computer system, the communication-conduit computer system and the waking computer system may be performed by a single physical computer system. The authentication computer system may be configured to assign a remote computing system to be accessed by the user identity operating the first computing system.

Implementations of any of the techniques discussed above may include a method or process, a system or apparatus, or computer software on a computer-accessible medium. The details of one or more implementations are set forth in the accompanying drawings and the description below. Other features, objects, and advantages will be apparent from the description and drawings, and from the claims.

### DESCRIPTION OF DRAWINGS

FIG. 1 is a block diagram of a system incorporating various aspects of the invention.

FIGS. 2A and 2B are an example of a process for remote access.

FIGS. 3 and 8 are block diagrams of example systems that enable remote access to software applications on a proprietary user system.

FIGS. 4-7 are block diagrams of example user interfaces enabling remote access to software applications on a proprietary user system.

Like reference symbols in the various drawings indicate like elements.

### DETAILED DESCRIPTION

To fully understand the techniques presented in this description, the challenges and issues of providing remote access to applications and data accessible through a proprietary network need to be understood. One challenge of providing remote access is minimizing exposure of proprietary data to loss or theft. For example, when proprietary data is copied to a laptop computer and the laptop computer is removed from the business premises for use off-site, the loss or theft of the laptop computer also results in the loss or theft of the proprietary data stored on the laptop computer. When proprietary data includes sensitive, private or confidential data of a person, the loss or theft of a laptop may require notification of the people whose data was lost or stolen, or require other actions to be taken. In another example, proprietary data also may be exposed to loss or theft when transferred over a network to a computer system used to remotely access proprietary data through a business computer system.

A further challenge involves providing remote access without subjecting a proprietary communications network or computer system to inadvertent or purposeful exposure to malicious software. Exposure to such software may occur when a user uploads documents or data to the proprietary user computer system. Examples of malicious software include spyware, viruses, Trojan horses and worms.

Another challenge of providing remote access is minimizing, or eliminating, installation and configuration of specialized communication software that may be needed for remote access. In some cases, specialized communication software must be installed and configured on any computer to be used to remotely access the employee's office computer system. Specialized communication software also may need to be installed on office computer system that is to be accessed. Installation and management of the specialized communication software generally requires human effort, often substantial human effort. Use of specialized communication software also may require payment of a license fee.

Yet another challenge is that remote access to software applications on a computer system may require that the computer system be left powered-on when the employee leaves the office. This may require an employee to anticipate a need for remote access while out of the office or, perhaps, may require a routine practice of leaving the office computer system powered-on when the employee is out of the office.

In general, techniques are described that enable a computer system to access applications and data through a proprietary user computer system in order to provide secure remote access. Screen images displayed by the proprietary user computer system being accessed are communicated to the computer system used to access the proprietary user computer system, and user input relative to the screen images is received from the accessing computer system and provided to the proprietary user computer system. In this way, a user is able to remotely access and use a proprietary user computer system.

The techniques help to reduce the likelihood that proprietary data accessible through the proprietary user computer system is exposed to loss or theft in that screen images are transferred to the accessing computer system. In other words, data files (such as documents, spreadsheets, and database records) do not need to be transferred to the accessing computer system or otherwise removed from the business premises for use by the employee.

The techniques also help protect the proprietary user computer system from exposure to malicious software because data files, which can be infected by malicious software, are not returned to the proprietary user computer system. In another aspect, end-user license fees and support related to remote access may be reduced when application programs need not be installed, configured and licensed to enable remote use of the applications by an end-user. End-user license fees and support also may be reduced when specialized communication software is not required for remote access.

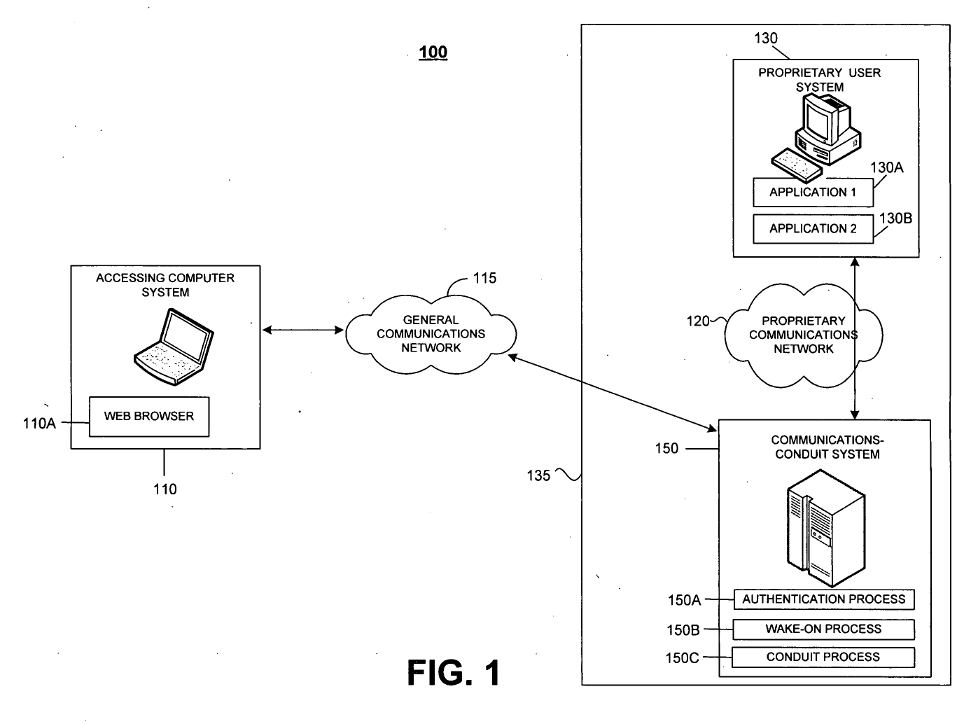

FIG. 1 is a simplified block diagram of a system 100 of networked computers, in which computer program products and methods for enabling remote access of a proprietary user computer system can be used. In this example, the system 100 includes a computer system 110 having a web browser 110A that is able to access, via a general communications network 115 and a proprietary communications network 120, a proprietary user computer system 130, on which software applications 130A and 130B reside. The computer systems 110 and 130 may be geographically dispersed. In this example, the proprietary user computer system 130 is physically located on premises occupied by a business enterprise (as indicated by box 135), whereas the accessing system 110 is present in another location, such as a hotel room, a personal residence or an airport. In general, a user activates and uses the web browser 110A on the computer system 110 to access and make use of software application 130A or 130B residing on the computer system 130. The computer system 110 also may be referred to as an accessing system 110. A communications-conduit computer system 150, also physically located on the premises 135, controls or facilitates communication between the accessing system 110 and the proprietary user computer system 130.

More particularly, the system 100 includes the computer systems 110, 130 and 150, all of which are capable of executing instructions on data. Each of the computer systems 110, 130 and 150 may be a general-purpose computer. Each of the computer systems 110 and 130 may be, for example, a desktop personal computer, a laptop computer or another type of portable computer, or a workstation. For brevity, FIG. 1 illustrates only a single accessing computer system 110 and a single proprietary user computer system 130. However, actual implementations may, and typically will, include multiple accessing computer systems and multiple proprietary user computer systems. The computer system 150 may be, and typically will be, a server or another type of computer system able to handle multiple, concurrent connections with other computer systems.

The accessing computer system 110 includes a web browser 110A, such as, for example, a version of Microsoft® Internet Explorer available from Microsoft Corporation of Redmond, Wash. or a version of Netscape® Browser available from Netscape Communications Corporation of Mountain View, Calif. The accessing computer system 110, using the web browser 110A, is configured to exchange messages over the general communications network 115. As such, the accessing computer system 110 and the communications-conduit computer system 150 are able to communicate via the general communications network 115. The communications-conduit computer system 150 is able to communicate with the proprietary user computer system 130 via a proprietary communications network 120. As such, the accessing computer system 110 is able to exchange communications with the proprietary user computer system 130 through the communications-conduit computer system 150.

The general communications network 115 typically includes a series of portals interconnected through a coherent system. In many cases, the general communications network 115 includes the publicly accessible Internet. Additionally or alternatively, the general communications network 115 may include a proprietary wide-area network (WAN), such as provided by an Internet service provider (ISP) or a network access provider that does not necessarily provide access to the Internet. Portions of the general communications network 115 may include, for example, one or more of a WAN, a local area network (LAN), an analog or digital wired and wireless telephone network (such as, the Public Switched Telephone Network (PSTN), an Integrated Services Digital Network (ISDN), or a Digital Subscriber Line of various types (DSL)), or any other wired or wireless network. The general communications network 115 may include multiple networks or subnetworks, each of which may include, for example, a wired or wireless data pathway. The general communications network 115 provides a direct or indirect communications link between the accessing computer system 110 and the communications-conduit computer system 150, independent of physical separation between the accessing computer system 110 and the communications-conduit computer system 150.

The proprietary communications network 120, typically, is a LAN, WAN or another type of wired or wireless network, which is operated, or controlled, by a business enterprise. In contrast to the general communications network 115, computer systems, peripheral devices or other devices connected to the proprietary communications network 120 are not generally accessible. Some portions of the proprietary communications network 120, however, may be publicly accessible. For example, the business enterprise may operate one or more web sites that are accessible to the general public and/or a more specialized population. Examples of a specialized population include business partners of the business enterprise, affiliates or re-sellers associated with the business enterprise, and people who subscribe to one or more particular programs or services offered by the business enterprise, such as a technical support program. In some cases, all, or some portions of a web site that is accessible to the general public may require that a user be identified or associated with a user account, such as requiring use of a user name based on an operating electronic mail (e-mail) account and a password associated with the user name. The proprietary communications network 120 may be implemented using commercially available networking equipment and software communication programs. The proprietary communications network 120, like the general communications network 115, may include multiple networks or sub-networks, each of which may include, for example, a wired or wireless data pathway.

The proprietary user computer system 130 includes a network interface (not shown) enabling the proprietary user computer system 130 to communicate with, via the proprietary communications network 120, the communications-conduit computer system 150. One example of a network interface is a network interface card (“NIC”), though a network interface need not necessarily be implemented as a circuit board or card. For example, a network interface may be implemented as a chip set that may be inserted into a socket of a computer system board.

The proprietary user computer system 130 also includes software applications 130A and 130B, in this example, are functionally different software applications that typically are used by a user of the proprietary user computer system 130 when the user is co-located with the proprietary user computer system (e.g., the user is present in the user's office). The software applications 130A and 130B each include stored instructions that are executed by a processor of the proprietary user computer system 130 to cause various operations of the software application to be performed. The software applications 130A and 130B each may include stored user data associated with the software application. In one example, software application 130A or 130B may be an office automation application, such as a version of Microsoft® Office Excel®, Word® or Powerpoint® available from Microsoft Corporation. In such a case, software application 130A or 130B may include the computer program licensed from the application developer and data created or modified by a user operating the computer program. Example of such data includes electronic documents created with a word processing computer program, presentations created by presentation computer program or spreadsheets created by a spreadsheet computer program. In another example, software application 130A or 130B may be a technical application, such as a modeling or simulation program, such as a version of MATLAB® available from MathWorks of Natick, Mass. In yet another example, software application 130A or 130B may be a computer program other than a commercial software application sold or licensed for use by many different business enterprises. In such a case, for example, software application 130A or 130B may be a computer program custom-developed for use specifically by the business enterprise. In another further example, software application 130A or 130B may be a client component of an enterprise information technology application, such as commercial software related to one or more business functions. Examples of business functions include financial management, customer relationship management or sales, supply chain management, order processing, shipping, and human resources management. In some implementations, data associated, or used, with software application 130A or 130B may be stored in a separate computer system or storage device that is accessible by the proprietary user computer system 130.

The communications-conduit computer system 150 includes instructions 150A for an authentication process that, when executed, authenticates the user of the accessing computer system 110. The user may be authenticated based on, for example, a valid combination of a user name and password, a valid security code generated by a security identification card, or a cryptographic credential. The authentication process 150A also determines whether the user, once authenticated, is associated with the proprietary user computer system 130 and thus permitted to access the particular user computer system 130 (as opposed to other user computer systems (not shown) that also may be connected to the proprietary communications network 120).

The communications-conduit computer system 150 also includes instructions 150B for a wake-on process that, when executed, powers-on the proprietary user computer system 130. To do so, the communications-conduit computer system 150 may send a wake-on message to a network interface of the proprietary user computer system 130, as described more fully later.

The communications-conduit computer system 150 also includes instructions 150C for a conduit process that, when executed, facilitates communications between the accessing system 110 and the proprietary user computer system 130, as described more fully later.

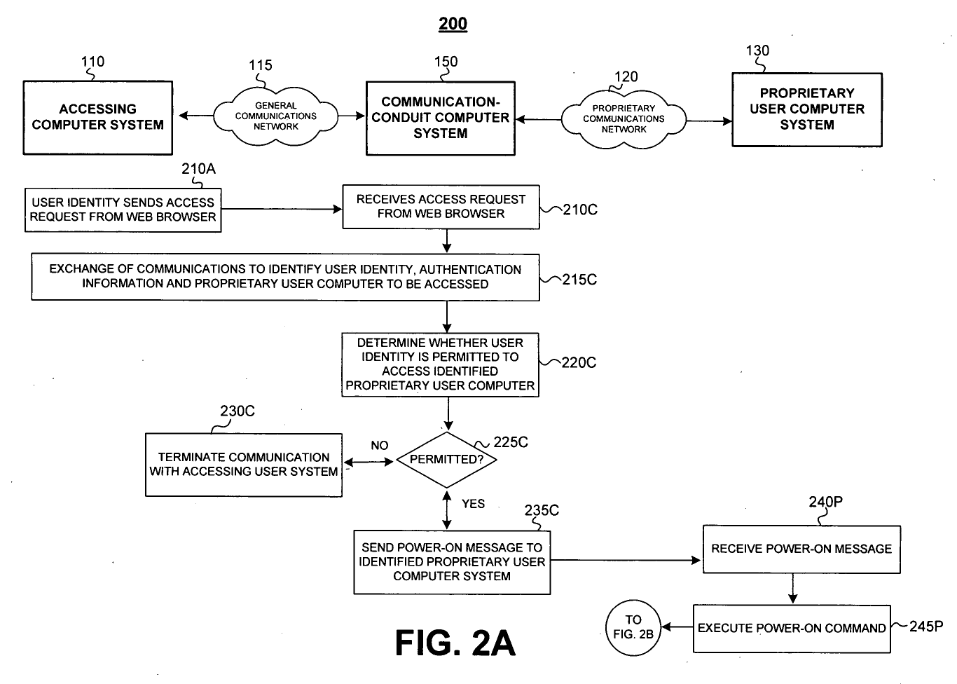

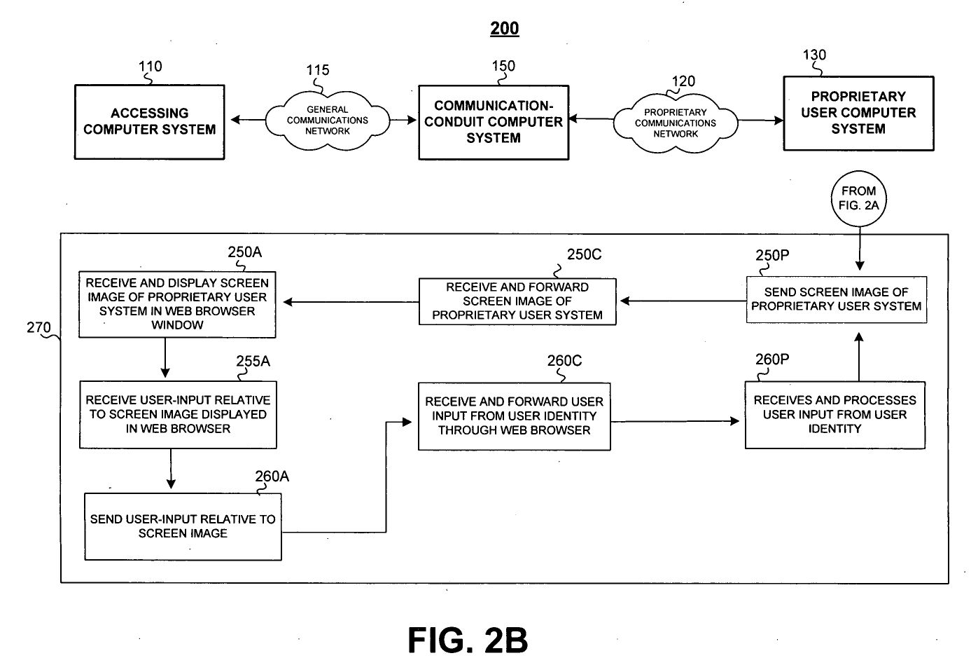

FIGS. 2A and 2B illustrate an example process 200 that enables a user of an accessing computer system 110 to remotely access proprietary user computer system 130. For convenience, the process 200 references particular componentry described with respect to FIG. 1. However, similar methodologies may be applied in other implementations where a different component is used to define the structure of the system, or where the functionality is distributed differently among the components shown in FIG. 1. The process 200 may be implemented, for example, by executing the authentication process 150A, the wake-on process 150B and the conduit process 150C, all of FIG. 1.

More particularly, the process 200 enables a user of the accessing computer system 110 to communicate with, via general communications network 115, a communication-conduit system 150. The communications-conduit computer system 150, in turn, communicates with, via a proprietary communications network 120, proprietary user computer system 130 to enable the user of the accessing user computer system 110 to operate software applications residing on the proprietary user computer system 130. The communications-conduit computer system 150 facilitates the remote access of the software applications residing on the proprietary user computer system, as described more fully below.

Referring to FIG. 2A, the process 200 may be manually initiated by the user of the accessing computer system 110 who desires to access a software application installed on the proprietary user computer system 130. The accessing computer system 110, in response to user input, uses the web browser to send an access request, over the general communications network 115, to the communications-conduit computer system 150 (step 210A). To do so, for example, the user may initiate or otherwise activate the web browser and use the web browser to initiate a communication session with the communications-conduit computer system 150. This may be accomplished, for example, by the user entering, into the web browser, a computer name, domain name or network address to identify the communications-conduit computer system 150 and then activating a control to initiate a communications session with the identified computer system 150. In another example, a user may use a pointing device (e.g., a mouse) to select the communications-conduit computer system 150 from a list of favorite places identified in the web browser.

The communications-conduit computer system 150 receives, via the general communications network 115, the access request sent from the web browser operating on the accessing computer system 110 and establishes a communication session with the accessing computer system 110 (step 210C). Establishing a communication session with the communications-conduit computer system 150 may involve a further exchange of messages between the communications-conduit computer system 150 and the accessing computer system 110.

The communications-conduit computer system 150 and the accessing computer system 110 exchange communications, including communications to identify the user of the accessing computer system 110, to provide information to authenticate the user, and to identify a particular proprietary user computer to be accessed (step 215C). Some or all of the information provided to the communications-conduit computer system 150 may be entered by the user of the accessing computer system 110 or may be retrieved from storage associated with the accessing computer system 110. For example, a user may be presented with an input screen to enter a user name and authentication information for use in identifying and authenticating the user. One examples of authentication information is a user name and password combination. Another example of authentication information is a security code (e.g., a sequence of characters) generated by a security identification card, such as an RSA SecurID® available from RSA Security of Bedford, Mass. In another example, the web browser may present a cookie or other type of stored information that identifies a user and/or a password. In yet another example, a user may identify a particular proprietary user computer system 130 to be accessed by selecting a computer system from a list of presented computer systems or may enter a computer system identifier (such as a network address or an alphanumeric computer identifier or name). In some implementations, the identity of the communications-conduit computer system to be accessed may be retrieved from storage on the accessing computer system 110 or may be retrieved from storage on, or associated with, the communications-conduit computer system 150.

The communications-conduit computer system 150 determines whether the user identity is permitted to access the identified proprietary user computer system (step 220C). To do so, for example, the communications-conduit computer system 150 authenticates the user identify based on the provided authentication information and determines whether the user identity, once authenticated, is permitted to access the identified proprietary user computer system 130. In one example, the communications-conduit computer system 150, to authenticate the user identity, may determine whether the received user name and password is a valid combination. In another example, the communications-conduit computer system 150 may determine whether a received security code is valid based on an association of the user identity and a security identification card used to generate the security code. In yet another example, a user identity may be validated based on more than one form of security, such as authentication of a user based on a valid user name and password combination and based on a valid security code from a security identification card.

To determine whether the user identity is permitted to access the identified proprietary user computer system 130, the communications-conduit computer system 150 may access a table, list or another type of data structure that is stored on computer-readable storage medium accessible to the communications-conduit computer system 150, where the data structure associates proprietary user computer systems and user identities. The communications-conduit computer system 150 determines whether the user identity of the accessing computer system 110 is permitted to access the proprietary user computer system based on an association of the user identity and the particular proprietary user computer system.

In one example, determining whether the user identity is permitted to access the identified proprietary user computer system 130 may be accomplished by using a table indexed by user name to look-up (or otherwise identify) a password and one or more proprietary user computer system identifiers that are associated with a particular user name. As shown below, the table may identify a user name, a password, and a proprietary user computer system associated with a user name. A user identity is permitted to access only a proprietary user computer system associated with the user name in the table. In the example of Table 1, a proprietary user computer system is identified using a static numeric Internet protocol (IP) address assigned to the proprietary user computer system. A proprietary user computer system also may be identified in other ways, such as by using an alphanumeric IP address or an identifier that is not associated with the computer itself.

TABLE 1

| | | Proprietary User Computer |
|---|---|---|
| User Name | Password | System Identifier |
| georgesmith | 552% NJKG | 163.52.128.72 |
| rthayward | JFH5654 | 163.52.128.78 |
| bjenkins | F994FJGH | 163.52.128.90 |

If the user identity is not permitted to access the identified proprietary user computer system (step 225C), the communications-conduit computer system 150 terminates the communication session with the accessing computer system 110 (step 230C). On the other hand, if the user is permitted to access the identified proprietary user computer system (step 225C), the communications-conduit computer system sends, via the proprietary communications network 120, to the identified proprietary user computer system 130 a power-on message (step 235C). To do so, the communications-conduit computer system 150 sends a power-on message to a network interface of the identified proprietary user computer system 130.

The proprietary user computer system 130 receives the power-on message (step 240P) and executes the power-on command indicated by the power-on message (step 245P). This may be accomplished, for example, when the network interface of the proprietary user computer system 130 receives a power-on message and executes a BIOS-level boot command indicated in the power-on message.

Referring also to FIG. 2B, the proprietary user computer system 130 sends to the communications-conduit computer system 150, via the proprietary communications network 120, a screen image of the proprietary user computer system (step 250P). The communications-conduit computer system 150 receives and forwards to the accessing computer system 110, via the general communications network 115, the screen image of the proprietary user computer system 130 (step 250C).

The accessing computer system 110 receives and displays the screen image of the proprietary user computer system 130 in a window of the web browser (step 250A). The accessing computer system 110 receives user input, entered by the user identity, relative to the screen image of the proprietary user computer system displayed in the web browser (step 255A). For example, a user may enter information or use a pointing device to activate a control in the window displayed in the web browser. The accessing computer system 110 sends to the communications-conduit computer system, via the general communications network 115, the user input received through the web browser (step 260A).

The communications-conduit computer system 150 receives and forwards, to the proprietary user computer system 130, via proprietary communications network 120, the user input received through the web browser (step 260C). The proprietary user computer system 130 receives and processes the user input received through the web browser (step 260P). The proprietary user computer system 130 sends to the communications-conduit computer system 150, via the proprietary communications network 120, a screen image of the proprietary user computer system 130 as described previously (step 250P). The sub-process 270 of steps 250P to 260P continues until the user of the accessing computer system 110 powers-off or otherwise ends the remote access communication session.

In this way, a user is able to remotely access a particular proprietary user computer system to access one or more software applications installed or otherwise usable through the proprietary user computer system. A user is also able to access data related to the one or more software applications. The remote access is enabled by the communications-conduit computer system 150 that controls or facilitates the communication between the accessing computer system 110 and the proprietary user computer system 130. In other words, the user of the accessing computer system 110 is able to operate software applications residing on a particular proprietary user computer system 130 to which the user is permitted to access. Notably, the accessing computer system 110 communicates over a general communications network with the communications-conduit computer system, which acts as an intermediary by communicating, over the proprietary communications network 120, with the proprietary user computer system 130. Screen images are communicated to the accessing computer system, and user input relative to the screen images is received from the accessing computer system. Thus, a user is able to remotely access and use the proprietary user computer system without subjecting the proprietary communications network 120 to inadvertent or purposeful exposure to malicious software that otherwise may occur when a user uploads documents or data to the proprietary user computer system. Examples of malicious software include spyware, viruses, Trojan horses and worms. In addition, a user need not transport or otherwise remove data that includes sensitive information from the business premises.

In addition, the user is only able to remotely access a particular proprietary user computer system or group of proprietary user computer systems and, thus, is not permitted general access to all or many of the proprietary user systems connected to the proprietary communications network. An important aspect is that a user is able access data residing on a proprietary computer system without the data being copied, transferred or otherwise removed from the premises in which the proprietary computer system resided. This, in turn, helps to reduce the risk of loss or theft of data. For example, proprietary data does not reside in persistent storage of the accessing computer system and, as such, is not vulnerable to loss or misappropriation if the accessing computer system itself is lost or stolen. In this way, the process 200 provides remote access without requiring movement of proprietary data outside of the premises in which the proprietary computer system resides.

The process 200 also enables the proprietary user computer system to-be powered-on. This relieves a user of the burden to anticipate a need for remote access before leaving the premises on which the proprietary user computer system is located. By enabling the proprietary user computer system to be powered-on to be remotely accessed, vulnerability of the proprietary user computer system to malicious use or hijacking by an unauthorized user may be reduced.

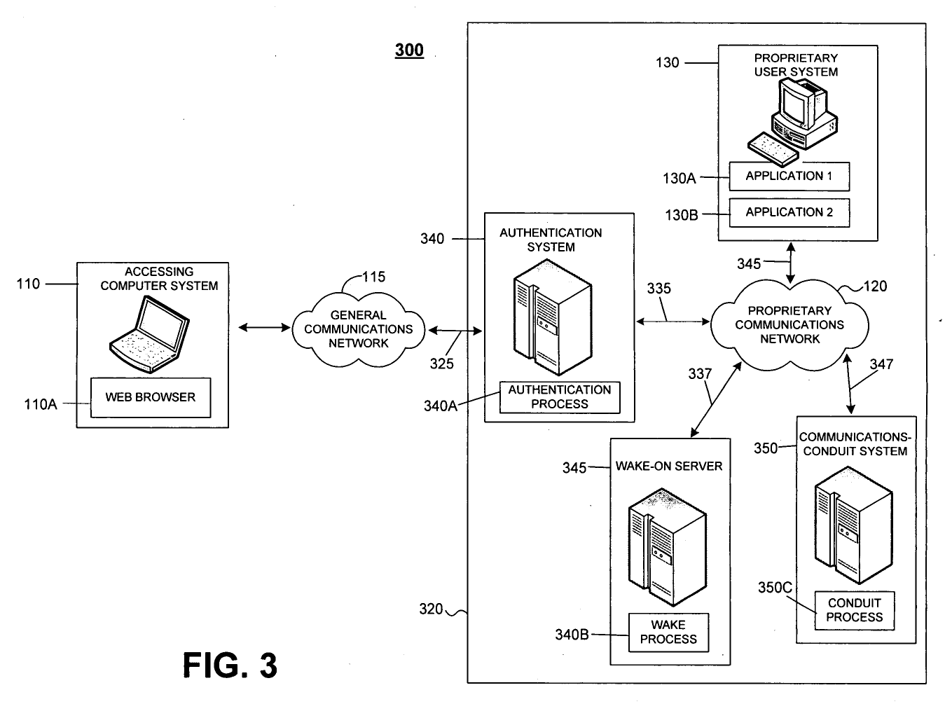

FIG. 3 illustrates another example communications system 300 that is capable of enabling remote access to a particular proprietary user computer system. For convenience, the communications system 300 shown in FIG. 3 references particular componentry described with respect to FIG. 1. However, similar methodologies may be applied to other implementations where different components are used to define the structure of the system, or where the functionality is distributed differently among the components shown by FIG. 3.

The communications system 300 includes an accessing computer system 110 having a web browser 110A and capable of remotely accessing, over a general communications network 115, business enterprise information technology system 320. More particularly, the accessing computer system 110 is able to use the web browser 110A to remotely access proprietary user computer system 130 to which the user operating the accessing computer system 110 is associated. Typically, the proprietary user computer system 130 is a computer system used by the user on a routine basis while the user is physically located on the premises of the business enterprise, though this need not necessarily be so. The communications system 300 permits the user of the accessing computer system 110 to access the proprietary user computer system 130 only after authentication of the user identity and verification that the user is permitted to access the particular proprietary user computer system 130. In contrast to the communications system 100 of FIG. 1, the communications system 300 includes an authentication system 340 configured to execute an authentication process 340A and a wake-on system 345 configured to execute a wake process 340B.

The accessing computer system 110 and the authentication sever 340 are able to exchange communications over the general communications network 115. The authentication system 340, the wake-on system 345, the communications-conduit computer system 350 and the proprietary user computer system 130 are able to communicate using the proprietary communications network 120.

Each of the authentication system 340 and the wake-on system 345 is a general-purpose computer capable of executing instructions. The instructions may take the form of one or more computer programs. Generally, each of the authentication system 340 and the wake-on system 345 are capable of hosting multiple concurrent communications sessions.

The authentication system 340 is configured to execute an authentication process 340A, which may be an implementation of authentication process 150A in FIG. 1. Conditioned upon a user identity associated with the accessing computer system 110 being authenticated and a determination having been made that the user identity may access the proprietary user computer system 130, the authentication server routes communications between the accessing computer system 110 and the communications-conduit computer system 350.

The wake-on system 345 includes a wake process 340B that, when executed, powers-on the proprietary user computer system 130. The wake process 340B may be an implementation of the wake process 150B in FIG. 1.

The communications-conduit computer system 350 includes a conduit process 350C, which may be an implementation of conduit process 150C in FIG. 1 or the sub-process 270 in FIG. 2. The communications-conduit computer system 350 is configured to execute the conduit process 350C. When executed, the conduit process 350C enables the communications-conduit computer system 350 to receive, over the proprietary communications network 120, a screen image from the proprietary user computer system and send, also over the proprietary communications network 120, the received screen image to the authentication system 340 for transmission, over the general communications network 115, to the accessing computer system 110. The conduit process 350C, when executed, also enables the communications-conduit computer system 350 to receive from the accessing computer system, via the general communications network 115 and indirectly through the authentication system 340, user input related to the screen image and to send, over the proprietary communications network 120, the user input to the proprietary user computer system 130.

Some implementations may include multiple authentication systems 340, and may use load balancing techniques to distribute workload across the multiple authentication servers 340. Some implementations also may include multiple wake-on systems 345 and/or multiple communications-conduit computer systems 350.

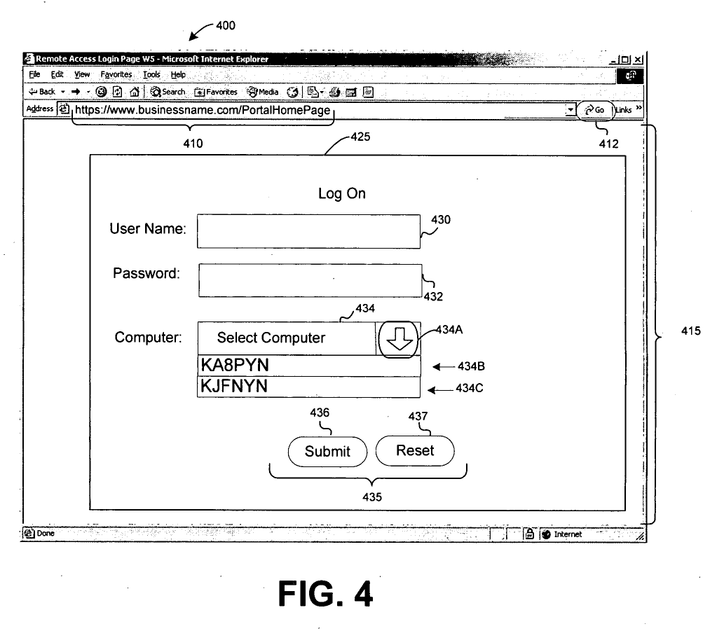

FIGS. 4-7 depict screen snapshots 400-700 displayed in the web browser running on the accessing computer system that illustrate the remote access process as it may be performed, for example, in the example system 300 shown in FIG. 3. In the example implementation, a user of a personal computer physically located at the user's residence (i.e., the accessing computer system 110) is able to access the user's personal computer physically located at the user's office (i.e., the proprietary user computer system 130). Both the accessing computer system and the proprietary user computer system operate a version of Microsoft® Windows® operating system, though this need not necessarily be so. Referring to FIG. 4, the example screen snapshot 400 depicts, in simplified form, a log-on screen running in the web browser window. The log-on screen 425 is presented in the web browser display portion 415 in response to a user entering or selecting the address of the business enterprise information technology system to be accessed in the address window 410 of the web browser and activating the “go” control 412. In response to activation of the “go” control 412, the accessing computer system establishes a communication session with the computer system identified in the address window 410. In the example of system 300, a communication session is established with authentication system 340, which sends the log-on screen 425 to the web browser for display.

The log-on screen 425 includes a user-name field 430, a password field 432, and a select computer field 434. The user identity operating the accessing computer system enters a user name in the field 430 and a password in field 432. The password entered in field 432 may include a one-time-use security code generated by a security identification card that the user enters into the password field 432. The password also may include a personal identification number that is associated with the security identification card issued to the user. The password may be masked as the user identity enters the password—that is, a character entered by the user identity may be displayed in the password filed 432 as a particular character (such as an asterisk) regardless of what character the user identity typed.

The user identity selects one of the identified proprietary user computer systems 434B or 434C made visible by activating drop-down arrow 434A to populate the computer field 434. In this example, identifiers for one or more proprietary user computer systems to which the user is permitted to access are presented for selection. Additionally or alternatively, a user may be required to enter a computer identifier to identify the proprietary user computer system to which the user seeks access. In this example, proprietary user computer system are identified by an alphanumeric identifier. Other implementations may use different types of identifiers.

In some implementations, validating that a user identity is permitted to access a particular proprietary user computer system may be implicit based on the presentation of the list of proprietary user computer systems 434B and 434C, from which the user selects.

The log-on screen 425 also includes controls 435. A submit control 436 is operable to use the web browser to send the contents of each of the user-name field 430, the password field 432, and the computer field 434 to the authentication system 340. A reset control 437 is operable to clear the fields 430, 432, and 434. When a password field 432 contents are masked, the content entered by the user identity is sent (rather than the masked character that is displayed).

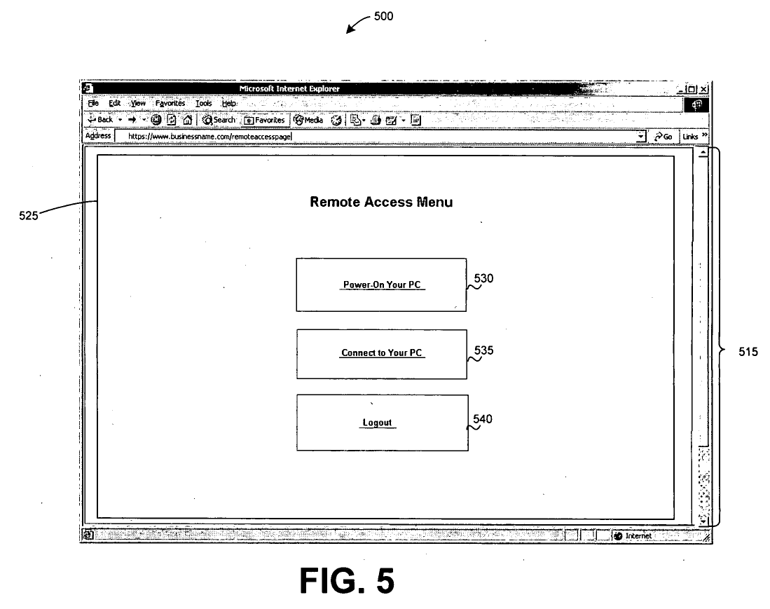

FIG. 5 illustrates, in simplified form, an example screen snapshot 500 of a web browser display that includes a remote access menu 525. The remote access menu 525 is presented in the web browser content portion 515 conditioned upon the authentication system 340 authenticating the user identity based on the user name and password submitted and validating that the user identity is permitted to access the identified proprietary user computer system. Validating that the user identity is permitted to access the selected proprietary user computer system may be implicit based on a user selecting one of presented identifiers for proprietary user computer system to which the user has been granted permission for remote access.

In some implementations, the remote access menu 525 may also include the identifier of the proprietary user computer system to which a selected option from the remote access menu is to be applied. In a context in which a user typically is only permitted to access one proprietary user computer system, the display of an identifier for the proprietary user computer system may be confusing to the user, unnecessary or otherwise disfavored.

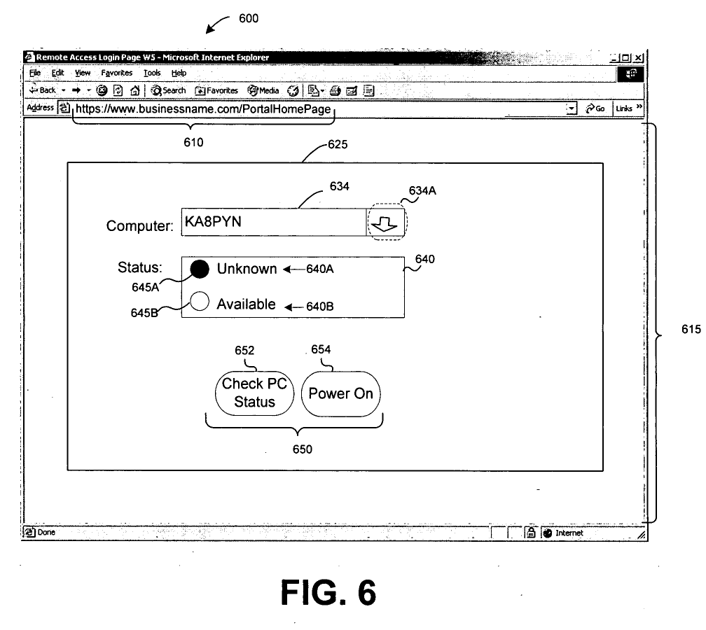

The remote access menu 525 includes a control 530 operable to present a power-on window, such as the example screen snapshot 600 of FIG. 6. Referring also to FIG. 6, the example screen snapshot 600 shows a power-on window 625 presented in the content area 615 of the web browser operating on the accessing computer system. The screen snapshot 600 displays the computer identifier 634 of the proprietary user computer system to be controlled through the power-on window 625. In some implementations, and as shown in FIG. 6, the power-on window 625 includes a drop-down arrow 634A that is selectable by the user identity and enables the user identity to select another proprietary user computer system to be controlled through the power-on window 625. The proprietary user computer system listed in response to activating the drop-down arrow 634A may be a list of proprietary user computer systems to which the user identity is permitted access. Other implementations may use different methods of identifying a different proprietary user computer system to be controlled, such as by requiring a user key a computer identifier into an input field. In any case, however, a user is only permitted to use the power-on window to power on or otherwise control a proprietary user computer system to which the user is permitted remote access.

The power-on window 625 also includes a smaller status window 640 related to the proprietary user computer system identified by computer identifier 634. More particularly, the status window 640 includes an unknown status 640A and an available status 640B indicating that the proprietary user computer system is powered on and available to be used. Each status 640A and 640B is associated with an indicator 645A and 645B, respectively. As shown, the indicator 645A corresponding to the unknown status 640A is selected. The unknown status 640A typically is indicated as a default status when the user first accesses the power-on window 625 during a remote access session. Often, the status of whether a particular proprietary user computer system is powered-on is not able to be determined without first exchanging one or more messages with the proprietary user computer system, which typically does not occur until the user has powered on the proprietary user computer system or has checked the status of the proprietary user computer system. The power-on window 625 also includes controls 650, which enable the user to do so.

More particularly, the power-on window 625 includes a control 652 operable to check the status of the proprietary user computer system identified in the computer identity 634. This may be accomplished, for example, by sending a status-check command to a network interface of the proprietary user computer system. In one example, where the network interface is a network interface card, a data structure may include an association of a network interface card identifier and a proprietary user computer system in which a network interface card is installed. A table may be indexed on an proprietary user computer system identifier that associates each proprietary user computer system with a MAC (“Media Access Control”) address of the network interface card. A status-check message is sent over the proprietary communications network addressed to the network interface card. If the proprietary user computer system is powered-on, a return message is generated so indicating and the indicator 645B is activated to indicate that the proprietary user computer system is available. On the other hand, when a response to the status-check message is not received within a predetermined period of time, the indicator 645A is activated to indicate the status is unknown.

The power-on window also includes a control 654 operable to power-on the proprietary user computer system identified in the computer identity 634. When activated, the control 654 initiates sending a power-on message to the network interface of the proprietary user computer system. When the power-on message is received by the network interface, the network interface powers-on the proprietary user computer system by initiating execution of a power-on command to boot or otherwise start-up the proprietary user computer system. Some implementations may display a message or a notice indicating that the process to check status or power-on the proprietary user computer system may take some period of time to alert the user identity of that possibility. Additionally or alternatively, the communications conduit computer system may use a network protocol to determine the status of the proprietary user computer system after sending the power-on message and, based on that communication exchange, update the status of the proprietary user computer system. For example, the communications conduit computer system may ping the proprietary user computer system to test whether the proprietary user computer system is reachable by sending an echo request and waiting for a reply. Once a reply is received, the communications conduit computer system may further test the availability of the proprietary user computer system by attempting to connect to the remote desktop of the proprietary user computer system to determine whether the proprietary user computer system is available.

Some implementations may provide additional control options. For example, a force-shutdown control may be useful to power-off the proprietary user computer system, and a force-reboot control may be useful to shutdown and restart the operating system of the proprietary user computer system. These controls may be particularly useful when the proprietary user computer system is unresponsive to software application commands (e.g., the software application “hangs”) or is unresponsive to operating system commands (e.g., the operating system “hangs”).

Referring again to FIG. 5, the remote access menu 525 also includes a control 535 operable to initiate a communication connection between the communications conduit system 350 and the proprietary user computer system 130 and initiate execution of a conduit process by the communications-conduit computer system. The conduit process passes a screen image of the display generated on the proprietary user computer system 130 to the accessing computer system and passes user input related to the screen image, received from the accessing computer system, to the proprietary user computer system. This enables the user of the accessing computer system to remotely access applications on the proprietary user computer system 130.

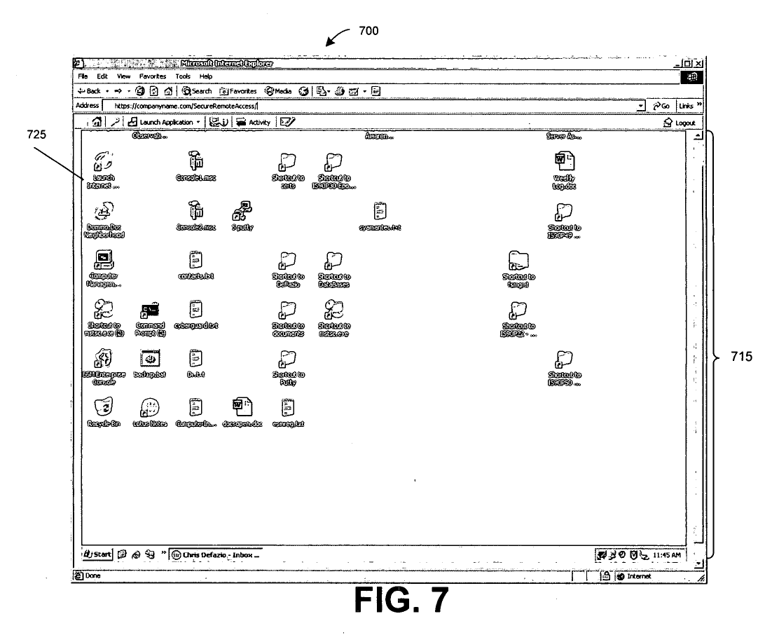

As depicted in FIG. 7, an example screen snapshot 700 shows a screen image 725 of a desktop of the proprietary user computer system 130, which is a screen image sent from the communications-conduit computer system 350 to the accessing computer system 110 via the general communications network 115. Notably, the screen image 725 of the desktop of the proprietary user computer system 130 is displayed in the content area 715 of the web browser. The user of the accessing computer system is able to enter input related to the screen image by using a pointing device or keyboard. The web browser receives and transmits, over the general communications network 115, the input to the communications-conduit computer system, which, in turn, transmits, over the proprietary communications network 120, the input to the proprietary user computer system 130. The proprietary user computer system 130 receives the input and processes the input using the appropriate software application.

In a more particular example, a user may manipulate a pointing device connected with the accessing computer system 110 to select and activate a icon displayed on the desktop screen image. The web browser transmits the manipulation relative to the desktop screen image, which is received by the communications-conduit computer system and transmitted to the proprietary user computer system, which processes the input as if the input was directly received from an input device connected to the proprietary user computer system. As such, a user may initiate and use a software application from the desktop screen image of the proprietary user computer system. In this manner, a user of the accessing computer system is able to remotely access software applications operating on, or through, the proprietary user computer system 130.

Referring again to FIG. 5, the remote access menu 525 also includes a control 540 to logout the user identity from the authentication system 340 and end the remote access session. The logout control 540 may be particularly useful when a user has not yet selected the control 535 to connect to the proprietary user computer system.

Another example of a remote access process may be implemented, for example, using a virtual private network and the Web Terminal Server® function available in some versions of Microsoft® Windows™ operating system. In this example implementation, authentication of the user identity is performed multiple times. In addition, in this example, the operating system of the proprietary user computer system is configured to enable remote access once prior to the first occasion of remote access. In addition, the first time that the web browser accesses the business enterprise information technology system, an ActiveX® component is downloaded to the accessing computer system to enable establishment and use of a virtual private network between the business enterprise information technology system and the accessing computer system.

In this example, a user identity logs into, and is authenticated by, the business enterprise information technology system in general, typically by entering a one-time security code generated by a security identification card. The user identity is required to be authenticated a second time before being permitted to initiate a wake process or to connect to the proprietary user computer system and beginning the conduit process of passing screen images and user-input between the proprietary user computer system and the accessing computer system. During the second authentication process, a determination is made as to whether the user identity is permitted to access the remote access function. This may be accomplished by determining whether the user identity is permitted to access the directory area that persistently stores instructions for the remote access function. A further determination is made as to whether the user identity is permitted to access one or more particular proprietary user computer systems. This determination may be made, for example, based on a data structure that associates a user name with one or more proprietary user computer systems that the user identity is permitted to access.

A remote access menu is presented that includes a wake-on process control to power-on a particular proprietary user computer system to which the user identity may access remotely. The presented remote access menu also includes a control to initiate a connection to the proprietary user computer system using the Web Terminal Server® function of the Windows™ operating system. Once the proprietary user computer system is powered on and the Web Terminal Server® function is initiated, the user receives an input screen to enter the identifier of proprietary user computer system to be accessed. Optionally, the user is able to identify and adjust the parameters used to display the remote screen image. In response to user-activation of a “Connect” control, a connection is established from the communications-conduit computer system to the proprietary user computer system. In response to the establishment of the connection, the proprietary user computer system displays the Windows™ log-in screen, a screen image of which is sent, via the proprietary communications network, to the communications-conduit computer system and forwarded over the general communications network to the accessing computer system. The user enters input in the web browser displaying the Windows™ log-in screen, and the web browser sends the log-in information to the communications-conduit computer system, which forwards the log-in information to the proprietary user computer system. In response to correct log-in information, the Windows™ desktop, such as desktop 725, is displayed on the proprietary user computer system and a screen image of the desktop is sent to the communications-conduit computer system, which, in turn, forwards the screen image to the accessing computer system. The user identity of the accessing computer system is able to access software applications installed on the proprietary user computer system as if the user identity was accessing the software applications by using input devices connected to the proprietary user computer system itself.

The ability to enable an end-user to remotely access applications on a proprietary user computer system by using a web browser to exchange, via a general communications network, screen images and user input related to the screen images may help be useful. For example, likelihood of contamination of the business enterprise information technology system by malicious software may be reduced. For example, documents and files that are uploaded to a proprietary user computer system from a computer system outside the business enterprise information technology system may contain malicious software that infects the business enterprise information technology system. By exchanging screen images and user input rather than files and documents, the likelihood of infecting the business enterprise information technology system is reduced, perhaps, greatly reduced.

The techniques and concepts described above also may be applied to other computing environments. In an example, a proprietary user computer system may be a workstation operating a version of the Unix operating system. In another example, a proprietary user computer system may be a workstation operating a version of the Solaris® operating system by Sun Microsystems, Inc. of Santa Clara, Calif. In another further example, an accessing computer system may be a computer system operating a version of Mac® OS and a Safari® Web Browser, both by Apple Computer, Inc. of Cupertino, Calif. In yet another example, an accessing computer system may be a computer system operating a version of Linux, such as a version of Linux available from Red Hat, Inc. In still another system, an accessing computer system may be an X Window system (which may otherwise be referred to as x-windows) running on version of Unix.

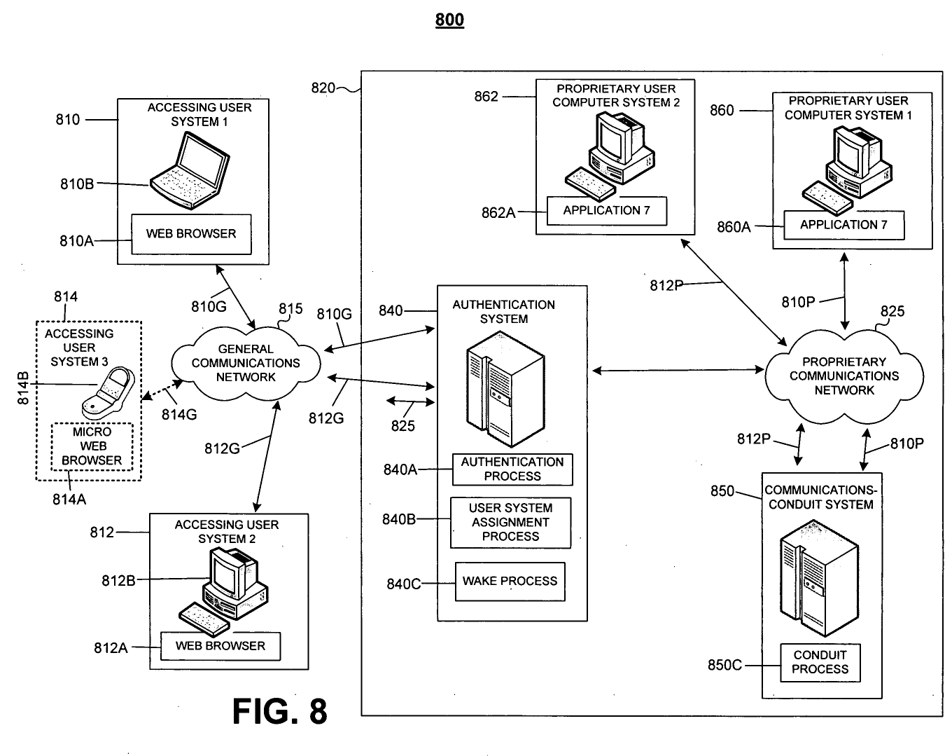

FIG. 8 presents yet another example communications system 800 that is capable of enabling remote access to a particular proprietary user computer system. In general, and in contrast with the communications system 100 in FIG. 1 and the communications system 300 in FIG. 3, the system 800 includes an information technology system 820 having multiple proprietary user computer systems 860 and 862, respectively, and is configured to assign one of the proprietary user computer systems 860 or 862 to a user seeking remote access. Also, in contrast to the communications system 100 in FIG. 1 or the communications system 300 in FIG. 3, the communications system 800 includes accessing user systems 810, 812 and 814, each having a form of a web browser.

More particularly, in the example of communication system 800, the accessing user system 810 is a laptop 810B (or another type of mobile computer), which has a web browser 810A. The accessing user system 812 is a desktop personal computer 812B, which has a web browser 812A. The accessing user system 814 is a mobile telephone 814B, which has a micro web browser 814B capable of communicating over the general communications network 815. Typically to do so, the mobile telephone 814B accesses a cellular network using cellular technologies, such as Advanced Mobile Telephone System, Narrowband Advanced Mobile Telephone Service, Frequency Shift Keying, Frequency Division Multiple Access, Time Division Multiple Access, and Code Division Multiple Access, or any standard, such as Global System for Mobile Communications (GSM) or Cellular Digital Packet Data (CDPD). The cellular network sends communications from the micro web browser, directly or indirectly, through the general communications network 815. An accessing user system 814 also may be another type of communications device, a personal digital assistant (PDA), or a mobile device that is a combination of a PDA and communications device.

The authentication system 840 includes an authentication process 840A, a process 840B for assigning users to one of the proprietary user computer systems 860 or 862, and a wake process 840C to power-on the assigned proprietary user computer system. In contrast to the authentication process 150A in FIG. 1 or 340A of FIG. 3, the authentication process 840A authenticates a user identity seeking remote access but does not determine whether a user is permitted to access a particular proprietary user computer system. Rather, the authentication system 840 is configured to assign one of the proprietary user computer systems 860 or 862 to the authenticated user who is seeking remote access. A user is only permitted to access a proprietary user computer system 860 or 862 to which the user has been assigned.

To assign a proprietary user computer system to a user, the authentication system 840 executes the assignment process 840B. The assignment process 840B, when executed, may cause the authentication system 840 to assign, to a user seeking remote access, a proprietary user computer system 860 or 862 that is not currently being used by another remote user. To determine whether a proprietary user computer system is being used by another remote user, the authentication system 840 may keep a list of proprietary user computer systems and indications of assignment in transient storage and check the list to identity whether a proprietary user computer system is available for assignment. Other data management techniques may also be employed. When no proprietary user computer system is available to be assigned, the authentication system 840 may send, to the accessing computer system seeking remote access, a message indicating that no proprietary user computer systems are presently available. In some implementations, the authentication system 840 may periodically check to see whether a proprietary user computer system is available and, if so, may send to the accessing user system a message indicating a proprietary user computer system is available.

In some implementations, the proprietary user computer systems 860 and 862 may have different capabilities, such as being configured to operate different software applications. For example, application software 860A may be different from application software 862A. The proprietary user computer systems 860 and 862 may have different processing and/or memory capacity. The authentication system 840 may assign a proprietary user computer system based on indications of capabilities needed by a user seeking remote access.

Conditioned upon a proprietary user computer system 860 or 862 being assigned to an accessing user system 810, 812 or 814, the authentication system 840 executes a wake process 840C to power-on the assigned proprietary user computer system 860 or 862, respectively.

The communications-conduit computer system 850 includes a conduit process 850C. The conduit process 850C, when executed, enables the communications-conduit computer system 850 to receive, over the proprietary communications network 825, a screen image from a proprietary user computer system 860 or 862 and forward the screen image to the accessing user system 810, 812 or 814 over the general communications network 815 (and through the authentication system 840). The conduit process 850, when executed, also enables the communications-conduit computer system 850 to receive, over the general communications network 815 (and through the authentication system 840), user input relative to the screen image from the accessing user system 810, 812 or 814. The conduit process 850 also enables the communications-conduit computer system 850 to send, over the proprietary communications network 825, the user input to the proprietary user computer system 860 or 862.

In one example of how the communications system 800 may be used, a user of the accessing user system 810 may use web browser 810A to initiate communications, over the general communications network 815, with the authentication system 840 of the information technology system 820. The communication exchange between the accessing user system 810 and the authentication system 840 is represented by communication pathways 810G. The authentication system 840 executes authentication process 840A, which may include exchange of a series of communications with the accessing user system 810 to receive a user name and authentication information. Conditioned upon authentication of the user identity of accessing user system 810, the authentication system 840 executes user-system assignment process 840B, which results in the assignment of proprietary user computer system 860 to the user identity of accessing user system 810. In some implementations, an assignment process 840B may be executed prior to, or substantially concurrent with, execution of the authentication process 840A. The authentication system 840 executes the wake process to power-on the proprietary user computer system 860.

The communications-conduit computer system 850 executes the conduit process 850C to receive, over the proprietary communications network 825, a screen image from the proprietary user computer system 860 communication pathways. The communication between the communications-conduit computer system 850 and the proprietary user computer system 860 is represented by communication pathways 810P. The communications-conduit computer system 850 indirectly forwards, over the general communications network 815, the screen image to the accessing user system 810. More particularly, the communications-conduit computer system 850 forwards, over the proprietary communications network 825, the screen image to the authentication system 840, which, in turn, sends the screen image to the accessing user system 810 over the general communications network 815.

The accessing computer system 810 receives and presents the screen image in a window displayed by the web browser 810A. The web browser 810 receives user input related to the screen image and forwards, over the general communications network 815, the user input to the communications-conduit computer system 850 (and does so indirectly by using the authentication system 840). The communications-conduit computer system 850 receives and forwards, over proprietary communications network 825, the user input to the proprietary user computer system 860 and the process is repeated with a new screen image from the proprietary user computer system 860. The execution of conduit process 850C continues with respect to proprietary user computer system 860 and accessing user system 810 until the user identity of the accessing user system 810 ends the conduit process 850C. To do so, for example, the user identity may power-off the proprietary user computer system 860 by using an operating system command to do so. Alternatively or additionally, the authentication system 840 may power-off the proprietary user computer system 860 once the user identity has indicated that remote access is to end. To do so, for example, the authentication system 840 may use an operating system command to power-off the proprietary user computer system 860. In this way, a user of accessing user system 810 may be able to remotely access the software application 860A on proprietary user computer system 860.

In a substantially similar manner, a user identity of accessing user system 812 may be authenticated and then assigned to proprietary user computer system 862 for access to the software application 862A. The accessing user system 812 communicates, over the general communications network 815, with the communications-conduit computer system 850 as represented by communication pathway 812G. The accessing user system 812 indirectly communicates with the communications-conduit computer system 850 through the authentication system 840. The communications-conduit computer system 850 communicates user input received from accessing computer system 812 to the proprietary user computer system 862 over the proprietary communications network 825, as represented by communications pathway 812P. Communications pathway 812P is also used to communicate screen images received from the proprietary user computer system 862 to the communications-conduit computer system 850.

As illustrated in the example of system 800, when the accessing user systems 810 and 812 are concurrently accessing application 860A of proprietary user computer system 860 or application 862A of proprietary user computer system 862, respectively, accessing user system 814 is unable to access a proprietary user computer system 860 or 862, as represented by the dotted line 814G.

In one example, the information technology system 820 may be a university computer laboratory that provides remote access to students or faculty members. In some implementations, a proprietary user computer system need not necessarily include input devices or display devices. For example, a remote-access computer facility may only support remote access by users (and not enable proximate access by a user in the same physical location as the proprietary user computer system). To do so, a remote-access computer facility may include multiple central processing units (CPUs) of computer systems without input devices or display devices, which may help reduce the cost of providing computer systems. In addition, the proprietary user computer systems consisting only of CPUs may be stored or mounted on racks, which may reduce the physical space required by the remote-access facility. This may help reduce the cost of the remote-access facility. A remote-access facility may be able to provide continuity of operations for one or more business enterprises, educational organizations, libraries, research institutions, and/or government organizations in event of a disaster when an organization's primary operational facility is not available. For convenience, a business enterprise, an educational organization or institute, a library, a research institution and a government organization that uses the remote-access facility for continuity of operations may be referred to as an organizational entity. This may be particularly useful in the context where an alternative worksite is not provided. For example, a displaced employee may work from the employee's residence by using a home personal computer to communicate with the information technology system provided by a remote-access facility.

The techniques and concepts of remote access have been generally described with reference to a business enterprise information technology system. Some or all of the techniques may be applied to other contexts, including, for example, a government information technology system, or an information technology system used by a non-for-profit organization, an educational institution, a library or a research institution.

The techniques and concepts also may enable remote access to a particular device connected to a home network. For example, a router or other type of gateway to a home network may be configured to authenticate a user seeking remote access, power-on a particular device (such as a computer system) in the home-network, and execute a conduit process. The conduit process executing on the home-network router sends screen images from the home-network device over a general communications network to an accessing system and provides, to the home-network device, user input related to a screen image, where the user input is received over the general communications network.

The invention can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the invention have been described. Nevertheless, it will be understood that various modifications may be made without departing from the spirit and scope of the invention. Accordingly, other implementations are within the scope of the following claims.

What is claimed is:

1. A computer implemented method for accessing a remote computing system, the method comprising:
receiving, at a conduit computing system, one or more user-initiated messages from a first computing system connected to the conduit computing system by a first network, at least one of the one or more user-initiated messages including information indicating authorization for access to a remote computing system connected to the conduit system by a second network;
in response to receiving the one or more user-initiated messages, sending, from the conduit computing system, a message over the second network to the remote computing system instructing the remote computing system to power on; and
channeling, by the conduit computing system, user input signals received over the first network from the first computing system and to the remote computing system to serve as inputs used in the execution of an application through the powered-on remote computer system, and in return, channeling, by the conduit computing system, screen images captured at the remote computing system and received over the second network from the remote computing system to the first computing system over the first network.

2. The method of claim 1 wherein the screen images are interactive screen images able to receive user-inputs from a user operating the first computing system.

3. The method of claim 1 wherein:
at least one of the one or more user-initiated messages includes a request to access a specified remote computing system connected to the conduit system by a second network,
only sending a message to the remote computing system after a determination is made that a user operating the authorized accessing computing system is permitted to access the specified remote computing system.

4. The method of claim 1, wherein the information indicating authorization for the requested access comprises user authentication information, further comprising assigning a remote computing system to be made accessible to a user identified by the user authentication information.

5. The method of claim 4 wherein the user is a user permitted to access a remote computing system provided by at least one of an educational institution, a library, or a research institution.

6. The method of claim 4 wherein the second network comprises a network operated for the purpose of continuity of operations and made available to multiple organizational entities.

7. The method of claim 6 wherein the second network is concurrently available to multiple organizational entities.

8. The method of claim 1 wherein the application resides on the powered-on remote computer system.

9. The method of claim 1 wherein the first computing system comprises at least one of a personal computer, a mobile computer, a personal digital assistant, and a mobile telephone.

10. The method of claim 1 wherein the information indicating authorization for access comprises a combination of a user name and a password, a single-use password, or a cryptographic authentication credential.

11. The method of claim 1, wherein the information indicating authorization for access to the remote computing system comprises information indicating authorization for access to a specific remote computing system, further comprising;
receiving, at the conduit computing system, a user-initiated message from the first computing system including information indicating authorization for access to the second network; and
channeling the user input signals and the screen images conditioned upon authorization for access to the second network and authorization for access to the specific remote computing system.

12. The method of claim 1 wherein the second network is a proprietary network operated by a business enterprise.

13. The method of claim 1 wherein the second network is a home network and the conduit computing system is a router operating as a gateway to the home network.

14. The method of claim 1 further comprising:
determining whether the remote computing system is powered-on prior to sending the message over the second network to the remote computing system instructing the remote computing system to power on, and
only in response to a determination that the remote computing system is not powered on, sending the message over the second network to the remote computing system instructing the remote computing system to power on.

15. The method of claim 1 wherein the first network is a general communications network and the second network is a proprietary communications network.

16. A system for accessing computer applications on a remote user computer, the system comprising:
an authentication computer system accessible over a first network and connected to a second network, the authentication computer system being configured to determine whether a user identity operating on a first computing system is permitted to access the second network;
a waking computer system connected to the second network, the waking computer system being configured to power-on a remote user computer conditioned upon a determination that the user identity is permitted to access the remote user computer; and
a communication-conduit computer system connected to the second network, the communication-conduit computer system being configured to channel, by the conduit computing system, user input signals received over the first network from the first computing system and to the remote computing system to serve as inputs used in the execution of an application through the powered-on remote computer system, and in return, channel, by the conduit computing system, screen images captured at the remote computing system and received over the second network from the remote computing system to the first computing system over the first network.

17. The system of claim 16 wherein the waking computer system is a different computer system than the communication-conduit computer system.

18. The system of claim 16 wherein the waking computer system is a same computer system as the communication-conduit computer system.

19. The system of claim 16 wherein functions performed by the authentication computer system, the communication-conduit computer system and the waking computer system are performed by a single physical computer system.

20. The system of claim 16 wherein the authentication computer system is further configured to assign a remote computing system to be accessed by the user identity operating the first computing system.

21. A computer program product tangibly embodied in an information carrier, the computer program product including instructions that, when executed, cause a remote access handling component to perform operations comprising:
receiving, over a first network from a first computing system, one or more user-initiated messages, at least one of the one or more user-initiated messages including information indicating authorization for access to a remote computing system accessible by a second network;
in response to receiving the one or more user-initiated messages, sending a message over the second network to the remote computing system instructing the remote computing system to power on; and
channeling user input signals received over the first network from the first computing system and to the remote computing system to serve as inputs used in the execution of an application through the powered-on remote computer system, and in return, channeling, by the conduit computing system, screen images captured at the remote computing system and received over the second network from the remote computing system to the first computing system over the first network.

22. The computer program product of claim 21 wherein the first network is a general communications network and the second network is a proprietary communications network.

23. The computer program product of claim 21 wherein the screen images are interactive screen images able to receive user-inputs from a user operating the first computing system.

24. The computer program product of claim 21 wherein the instructions, when executed, further cause the remote access handling component to sending a message to the remote computing system only after a determination is made that a user operating the authorized accessing computing system is permitted to access a remote computing system that is specified in at least one of the one or more user-initiated messages.

25. The computer program product of claim 21 wherein the instructions, when executed, further cause the remote access handling component to assign a remote computing system to be made accessible to a user identified by at least one of the one or more user-initiated messages.

26. The computer program product of claim 21 wherein the instructions, when executed, further cause the remote access handling component to perform operations comprising:
determining whether the remote computing system is powered-on prior to sending the message over the second network to the remote computing system instructing the remote computing system to power on, and
only in response to a determination that the remote computing system is not powered on, sending the message over the second network to the remote computing system instructing the remote computing system to power on.
